(19) United States
(12) Patent Application Publication
(10) Pub. No.: US 2025/0148044 A1
(43) Pub. Date: May 8, 2025

(54) METHOD AND SYSTEM FOR CONFIGURING PREPROCESSING FOR SUPERVISED LEARNING MODEL

(71) Applicant: MITSUBISHI ELECTRIC CORPORATION, Tokyo (JP)

(72) Inventors: Ken FUKUCHI, Tokyo (JP); Teng-Yok LEE, Tokyo (JP)

(73) Assignee: MITSUBISHI ELECTRIC CORPORATION, Tokyo (JP)

(21) Appl. No.: 19/020,312

(22) Filed: Jan. 14, 2025

Related U.S. Application Data
(63) Continuation of application No. PCT/JP2022/033490, filed on Sep. 7, 2022.

(51) Int. Cl. G06F 17/13

(52) U.S. Cl. CPC G06F 17/13

(57) ABSTRACT

A method comprises defining a function g with parameters a to l; disposing the function g previous to a supervised learning model f; the supervised learning model f being trained with training data TDi including an example xi and a label yi; defining a function f(g(xi)); calculating a result Zi by calculating the function f(g(xi)); calculating a difference Li between the result Zi and the label yi; calculating a partial differential PDi of the difference Li on the parameters a to l; updating the parameters a to l according to the partial differential PDi; defining a pseudo preprocessing h by using the parameters a to l when the difference Li converges; disposing the pseudo preprocessing h previous to the supervised learning model f; and training the supervised learning model f by providing the training data TDi to the pseudo preprocessing h.

### CROSS REFERENCE TO RELATED APPLICATIONS

This application is a Continuation of PCT International Application No. PCT/JP2022/033490 filed on Sep. 7, 2022, which is hereby expressly incorporated by reference into the present application.

### TECHNICAL FIELD

The present disclosure relates to methods and systems for configuring preprocessing used for a supervised learning model, and more particularly to methods and systems for evaluating a plurality of parameters used in the preprocessing.

### BACKGROUND ART

The object detecting device taught in Japanese Patent Laid-Open No. 2019-219804 has performed preprocessing to an image photographed with a camera, thus detecting an object in the image. For the purpose of enhancing the accuracy of detecting the object, the object detecting device adjusts a plurality of parameters included in the preprocessing, prior to performing the preprocessing.

FIG. 23 shows a conventional designing of preprocessing used for a supervised learning model. In FIG. 23, there is preprocessing PP1 that an engineer E(A) has designed for a supervised learning model SLM (used for 32-bit processing) by using training data TD1 to TDn (n is an integer equal to or more than two). Herein, it is assumed that the preprocessing PP1 includes a plurality of parameters, which are for example, unreproducible by or unknown to an engineer E(B) and other engineers, and the engineer E(B) attempts to divert or transfer the supervised learning model SLM from 32-bit processing to 64-bit processing.

The engineer E(B), however, cannot reproduce the plurality of parameters used for the preprocessing PP1 owing to the plurality of parameters being unreproducible or unknown, thereby configuring another preprocessing PP2 with a plurality of any other inappropriate parameters different from the plurality of parameters used in the preprocessing PP1. Consequently, the engineer E(B) cannot divert or transfer the supervised learning model SLM from 32-bit processing to 64-bit processing.

### CITATION LIST

### Patent Literature

[PTL 1]: JP 2019-219804 A

### SUMMARY OF THE INVENTION

To solve the above problem, an aspect of the present disclosure provides a method that comprises: defining a function g with a plurality of parameters a to l; disposing the function g previous to a supervised learning model f; the supervised learning model f being trained with training data TDi including an example xi and a label yi, and i being an integer; defining a function f(g(xi)) by using the supervised learning model f and the function g; calculating a result Zi by calculating the function f(g(xi)); calculating a difference Li between the result Zi and the label yi; calculating a partial differential PDi of the difference Li on the plurality of parameters a to l of the function g; updating the plurality of parameters a to l of the function g according to the partial differential PDi; defining a pseudo preprocessing h by using the plurality of parameters a to l of the function g when the difference Li converges during repetition between the calculating of the result Zi and the updating of the plurality of parameters a to l of the function g; disposing the pseudo preprocessing h previous to the supervised learning model f; and training the supervised learning model f by providing the training data TDi to the pseudo preprocessing h.

Another aspect of the present disclosure provides a method that comprises: acquiring a first plurality of combinations COMB_a1 to COMB_l1 that each include a variety of values on one of a plurality of parameters a to l of a first function g1 that is disposed previous to a first supervised learning model f1 that implements feedback to the first function g1, by providing training data TDi to the first supervised learning model f1, i being an integer; acquiring a second plurality of combinations COMB_a2 to COMB_l2 that each include a variety of values on one of a plurality of parameters a to l of a second function g2 that is disposed previous to a second supervised learning model f2 that is implements feedback to the second function g2, by providing training data TDi to the second supervised learning model f2, operation of the first supervised learning model f1 and operation of the second supervised learning model f2 being equivalent to each other; calculating a first plurality of distributions D_a1 to D_l1 on the first plurality of combinations COMB_a1 to COMB_l1 respectively; calculating a second plurality of distributions D_a2 to D_l2 on the second plurality of combinations COMB_a2 to COMB_l2 respectively; and evaluating which of the first function g1 and the second function g2 is more robust by comparing the first plurality of distributions D_a1 to D_l1 and the second plurality of distributions D_a2 to D_l2 respectively.

Still another aspect of the present disclosure provides a method that comprises: acquiring a plurality of combinations COMB(1) to COMB(n) that each include a plurality of values on a plurality of parameters a to l of a function g that is disposed previous to a supervised learning model f that implements feedback to the function g, by providing training data TDi to the supervised learning model f, n being an integer equal to or more than two; disposing the plurality of combinations COMB(1) to COMB(n) in space that has a plurality of dimensions of which number is equivalent to a number of the plurality of parameters a to l of the function g; acquiring at least one sampled point SP in the space; selecting at least one among the plurality of combinations COMB(1) to COMB(n) that is closest to the at least one sampled point SP; and assigning the plurality of values included in the selected one of the plurality of combinations COMB(1) to COMB(n) to the plurality of parameters a to l of the function g.

Still another aspect of the present disclosure provides a device comprising: a first definer that defines a function g with a plurality of parameters a to l; a first disposer that disposes the function g previous to a supervised learning model f; the supervised learning model f being trained with training data TDi including an example xi and a label yi, and i being an integer; a second definer that defines a function f(g(xi)) by using the supervised learning model f and the function g; a first calculator that calculates a result Zi by calculating the function f(g(xi)); a second calculator that calculates a difference Li between the result Zi and the label yi; a third calculator that calculates a partial differential PDi of the difference Li on the plurality of parameters a to l of the function g; a updater that updates the plurality of parameters a to l of the function g according to the partial differential PDi; a third definer that defines a pseudo preprocessing h by using the plurality of parameters a to l of the function g when the difference Li converges during repetition between the calculating of the result Zi and the updating of the plurality of parameters a to l of the function g; a second disposer that disposes the pseudo preprocessing h previous to the supervised learning model f; and a trainer that trains the supervised learning model f by providing the training data TDi to the pseudo preprocessing h.

Still another aspect of the present disclosure provides a device comprising: an first acquirer that acquires a first plurality of combinations COMB_a1 to COMB_l1 that each include a variety of values on one of a plurality of parameters a to l of a first function g1 that is disposed previous to a first supervised learning model f1 that implements feedback to the first function g1, by providing training data TDi to the first supervised learning model f1, i being an integer; a second acquirer that acquires a second plurality of combinations COMB_a2 to COMB_l2 that each include a variety of values on one of a plurality of parameters a to l of a second function g2 that is disposed previous to a second supervised learning model f2 that is implements feedback to the second function g2, by providing training data TDi to the second supervised learning model f2, operation of the first supervised learning model f1 and operation of the second supervised learning model f2 being equivalent to each other; a first calculator that calculates a first plurality of distributions D_a1 to D_l1 on the first plurality of combinations COMB_a1 to COMB_l1 respectively; a second calculator that calculates a second plurality of distributions D_a2 to D_l2 on the second plurality of combinations COMB_a2 to COMB_l2 respectively; and an evaluator that evaluates which of the first function g1 and the second function g2 is more robust by comparing the first plurality of distributions D_a1 to D_l1 and the second plurality of distributions D_a2 to D_l2 respectively.

Still another aspect of the present disclosure provides a device comprising: a first acquirer that acquires a plurality of combinations COMB(1) to COMB(n) that each include a plurality of values on a plurality of parameters a to l of a function g that is disposed previous to a supervised learning model f that implements feedback to the function g, by providing training data TDi to the supervised learning model f, n being an integer equal to or more than two; a disposer that disposes the plurality of combinations COMB(1) to COMB(n) in space that has a plurality of dimensions of which number is equivalent to a number of the plurality of parameters a to l of the function g; a second acquirer that acquires at least one sampled point SP in the space; a selector that selects at least one among the plurality of combinations COMB(1) to COMB(n) that is closest to the at least one sampled point SP; and an assigner that assigns the plurality of values included in the selected one of the plurality of combinations COMB(1) to COMB(n) to the plurality of parameters a to l of the function g.

### BRIEF DESCRIPTION OF DRAWINGS

FIG. 1 is a block diagram showing a configuration of a controlled system CS that is controlled by a controlling device CD according to a first embodiment.

FIG. 2 shows a configuration of a function g according to the first embodiment.

FIG. 3 shows configurations of training data TD1 to TDn.

FIG. 4 is a block diagram showing a configuration of the controlling device CD according to the first embodiment from a functional viewpoint.

FIG. 5 is a block diagram showing a configuration of the controlling device CD according to the first embodiment from a hardware viewpoint.

FIG. 6 is a block diagram showing a configuration of the controlling device CD according to the first embodiment from a software viewpoint.

FIG. 7 is a flowchart showing an operation (part 1) of the controlling device CD according to the first embodiment.

FIG. 8 is a flowchart showing an operation (part 2) of the controlling device CD according to the first embodiment.

FIG. 9 shows a configuration of the controlling device CD according to the first embodiment when i reaches to 80.

FIG. 10 is a block diagram showing configurations of a first controlled system CS1 and a second controlled system CS2 that are controlled by a controlling device CD according a the second embodiment.

FIG. 11 is a block diagram showing a configuration of the controlling device CD according to the second embodiment from the functional viewpoint.

FIG. 12 is a flowchart showing an operation of the controlling device CD according to the second embodiment.

FIG. 13 shows a plurality of combinations COMB_a1 to COMB_l1 including a variety of values on a plurality of parameters a to l of the first function g1.

FIG. 14 shows a plurality of combinations COMB_a2 to COMB_l2 including a variety of values on a plurality of parameters a to l of the second function g2.

FIG. 15 shows a plurality of distributions D_a1 of the combination COMB_a1 to D_l1 of the combination COMB_l1, and a plurality of distributions D_a2 of the combination COMB_a2 to D_l2 of the combination COMB_l2.

FIG. 16 is a block diagram showing a configuration of a controlled system CS that is controlled by a controlling device CD according to a third embodiment.

FIG. 17 is a block diagram showing a configuration of the controlling device CD according to the third embodiment from the functional viewpoint.

FIG. 18 is a flowchart showing an operation of the controlling device CD according to the third embodiment.

FIG. 19 shows a plurality of combinations COMB(1) to COMB(n) including a variety of values related to a plurality of parameters a to l of the function g.

FIG. 20 shows the plurality of combinations COMB(1) to COMB(n) and a sampled point SP that are disposed in space.

FIG. 21 shows the plurality of combinations COMB(1) to COMB(n) and an unexpected sampled point SP.

FIG. 22 shows the plurality of combinations COMB(1) to COMB(n) and several sampled points SP1, SP2, and SP3.

FIG. 23 shows a conventional designing of preprocessing used for a supervised learning model.

### DESCRIPTION OF EMBODIMENTS

To describe the present disclosure further in detail, embodiments of the present disclosure will be described below with reference to the accompanying drawings.

### First Embodiment

### Configuration of First Embodiment

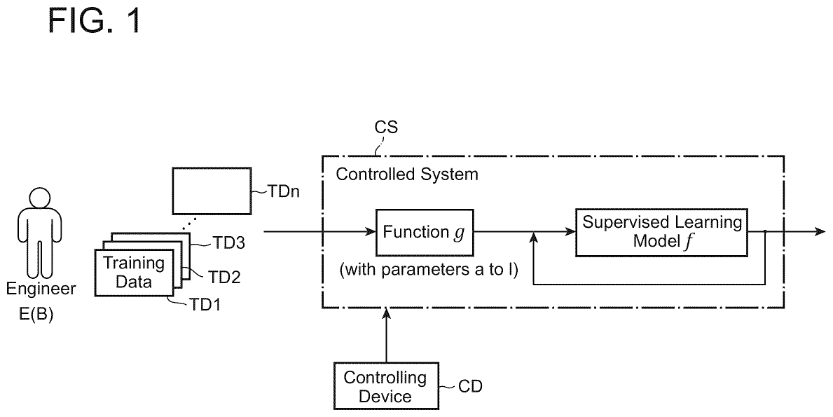

A controlling device according to a first embodiment of this disclosure will now be described with reference to FIGS. 1 to 9.

FIG. 1 is a block diagram showing a configuration of a controlled system CS that is controlled by a controlling device CD according to the first embodiment. The controlling device CD controls, for example, a configuration and an operation of the controlled system SC.

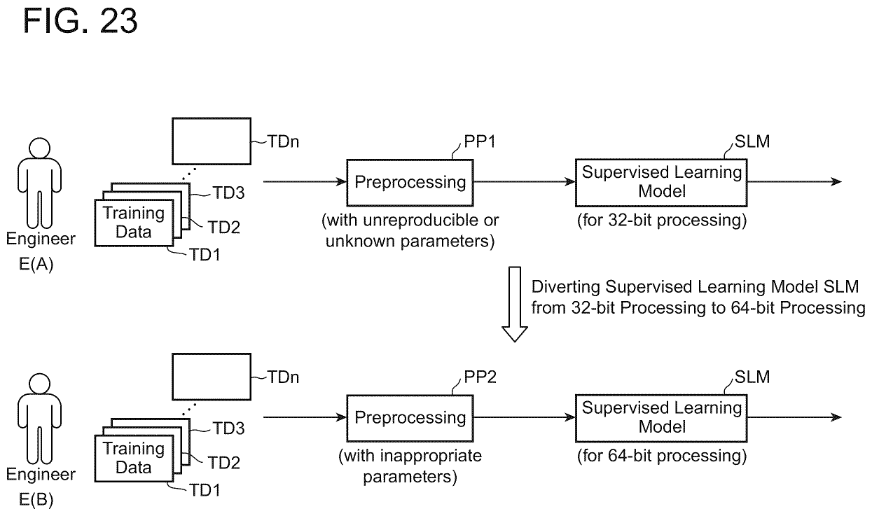

As shown in FIG. 1, the controlled system CS includes a supervised learning model f and a function g. The configuration of the supervised learning model f has already and completely been designed by an engineer E(A) (shown in FIG. 23), and another engineer E(B) desires to train the operation of the supervised learning model f by using training data TD1 to TDn (n is an integer equal to or more than two). The function g is an arbitrary function, which includes a plurality of parameters a to l.

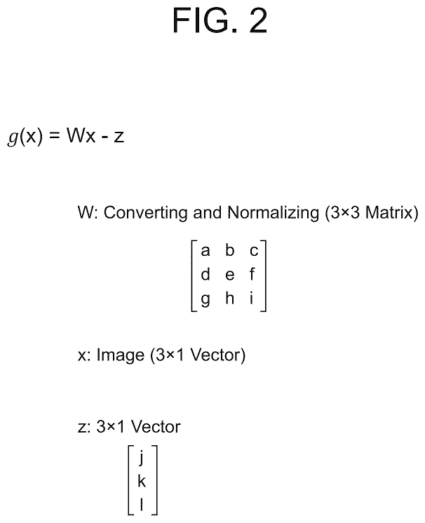

FIG. 2 shows a configuration of the function g according to the first embodiment. As shown in FIG. 2, the function g, that is, g(x) is represented by using W, x, and z. As shown in FIG. 2, W is a matrix, for example, for converting and normalizing (for example, a 3-row by 3-line vector), x is an input image (for example, a 3-row by 1-line vector), and z is a vector (for example, a 3-row by 1-line vector). Herein, as shown in FIG. 2, W is composed of a plurality of parameters a to i, and z is composed of a plurality of parameters j to l, which leads to a conclusion that the function g, that is, g(x) is composed of all those parameters a to l.

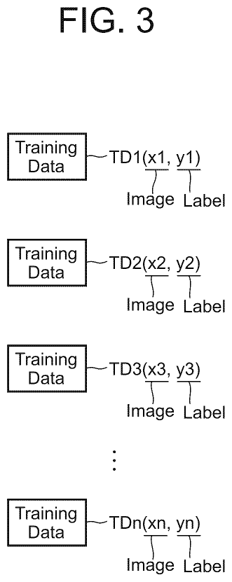

FIG. 3 shows configurations of training data TD1 to TDn. As shown in FIG. 3, for example, the training data TD1 has an image x1 as an example for training and a label y1. Herein, the label y1 is a correct answer that shows whether or not the image x1, that is, the example x1 is correct or not when training the supervised learning model f. Similar to the training data TD1, the training data TD2 has an image x2 and a label y2, the training data TD3 has an image x3 and a label y3, , , , and the training data TDn has an image xn and a label yn.

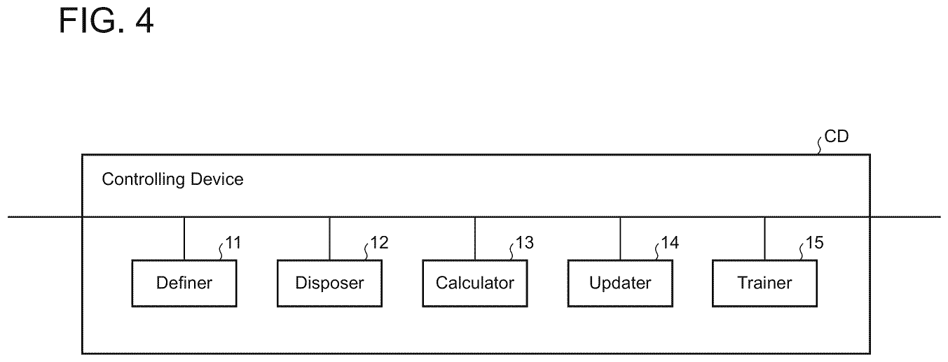

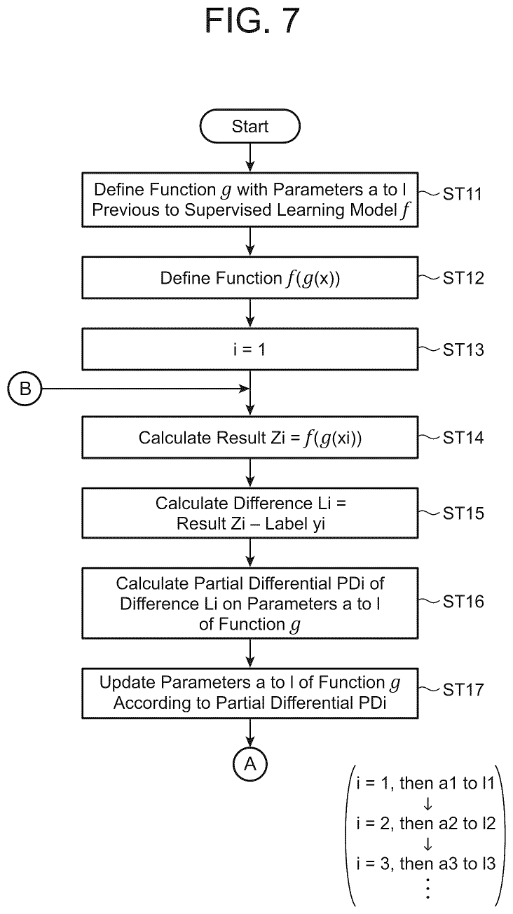

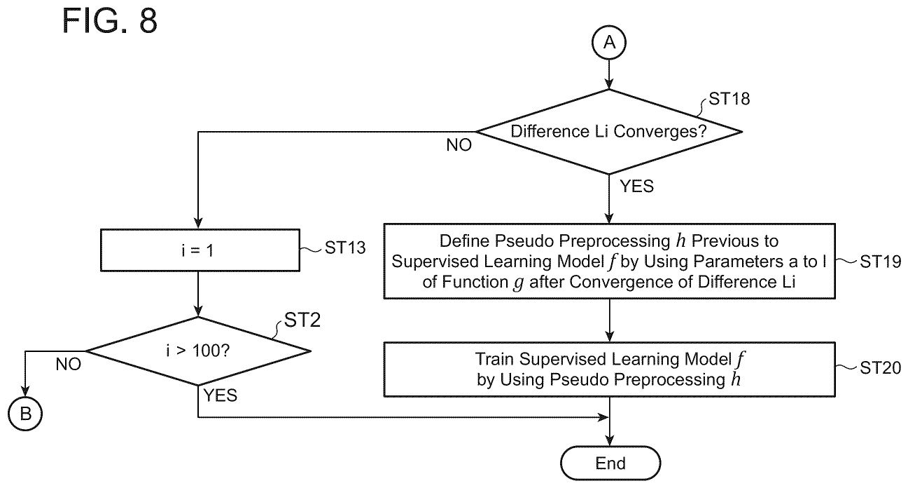

FIG. 4 is a block diagram showing a configuration of the controlling device CD according to the first embodiment from a functional viewpoint. As shown in FIG. 4, the controlling device CD according to the first embodiment includes a definer 11, a disposer 12, a calculator 13, an updater 14, and a trainer 15. The functions thereof will later be described with reference to the flowcharts of FIGS. 7 to 8.

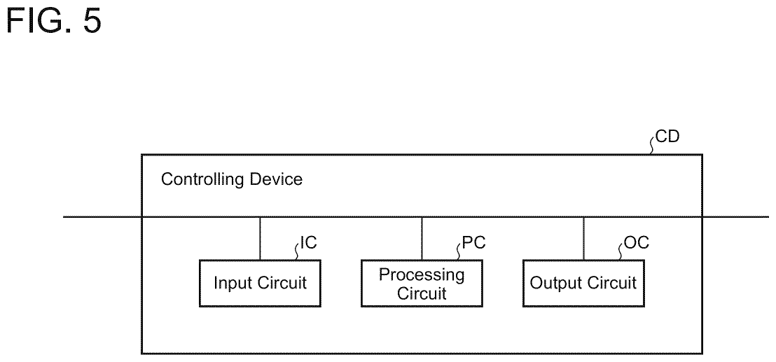

FIG. 5 is a block diagram showing a configuration of the controlling device CD according to the first embodiment from a hardware viewpoint. As shown in FIG. 5, the controlling device CD includes an input circuit IC, a processing circuit PC, and an output circuit OC.

The processing circuit PC is an dedicated hardware. The processing circuit PC implements the functions of the definer 11, the disposer 12, the calculator 13, the updater 14, and the trainer 15 shown in FIG. 4.

The processing circuit PC is, for example, a single circuit, a compound circuit, a programmed processor, a processor programmed in parallel, an ASIC (Application Specific Integrated Circuit), an FPGA (Field Programmable Gate Array), or a combination thereof.

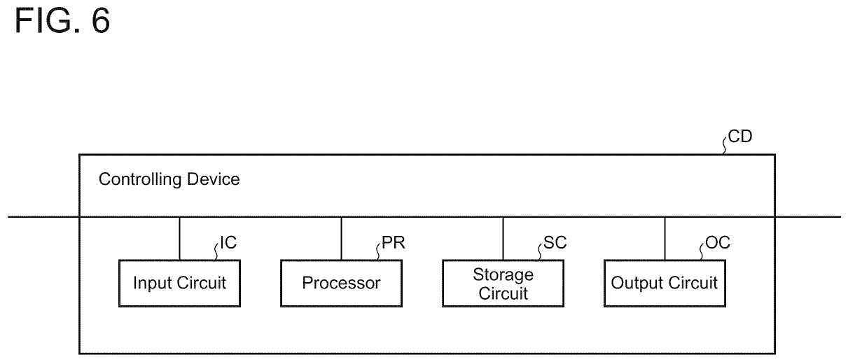

FIG. 6 is a block diagram showing a configuration of the controlling device CD according to the first embodiment from a software viewpoint. As shown in FIG. 6, the controlling device CD includes an input circuit IC, a processor PR, a storage circuit SC, and an output circuit OC.

The processor PR is, for example, a CPU (including a Central Processing Unit, a Central Processing Device, a Processing Device, an arithmetic device, a microprocessor, a microcomputer, or a DSP (Digital Processing)). The processor PR implements the functions of the definer 11 through the trainer 15 shown in FIG. 4.

The processor PR implements the functions above by using software, firmware, or combination of software and firmware. Software and firmware are described as a program, which is stored in the storage circuit SC.

The processor PR implements the function above by reading out the program from the storage circuit SC and executing the program. In other words, the program above enables a computer to execute procedures and methods of the definer 11 to the trainer 15.

Herein, the storage circuit SC, is for example, a volatile or non-volatile semiconductor memory, which includes a RAM (Random Access Memory), a ROM (Read Only Memory), a flash memory, an EPROM (Erasable Programmable Read Only Memory, and an EEPROM (Electrically Erasable Programmable Read Only Memory); a magnetic disk; a flexible disk; an optical disk; a compact disk; or a DVD (Digital Versatile Disc).

Among the functions of the definer 11 to the trainer 15, some functions may be implemented by the processing circuit PC while other functions may be implemented by the processor PR.

As described above, the functions of the definer 11 to the trainer 15 in the controlling device CD may be implemented by using hardware, software, firmware, or combination thereof.

### Operation of First Embodiment

FIG. 7 is a flowchart showing an operation (part 1) of the controlling device CD according to the first embodiment.

FIG. 8 is a flowchart showing an operation (part 2) of the controlling device CD according to the first embodiment.

For ease of explanation and understanding, it is assumed that an integer i can count up to 100, and a difference Li converges when the integer i reaches to 80.

At step ST11, the definer 11 (shown in FIG. 4) defines a function g (shown in FIG. 1) with the plurality of parameters a to l (shown in FIG. 2). In addition thereto, the definer 11 initializes the plurality of parameters a to l. After the initialization by the definer 11, the disposer 12 (shown in FIG. 4) disposes or set the function g previous to the supervised learning model f (shown in FIG. 1) as shown in FIG. 1.

At step ST12, the definer 11 defines a function f(g(x)) by using the supervised learning model f and the function g. Herein, the function f(g(x)) is formed in a nested manner, that is, the function g provides an output depending on an input image x (shown in FIG. 2), and the supervised learning model f provides an output depending on the output provided from the function g.

At step ST13, the definer 11 initializes the integer i, that is, sets 1 to the integer i.

At step ST14, the calculator 13 (shown in FIG. 4) calculates a result Zi of the function f(g(xi).

At step ST15, the calculator 13 calculates a difference Li between the result Zi and the label yi (shown in FIG. 3) by subtracting the label yi from the result Zi.

At step ST16, the calculator 13 calculates a partial differential PDi of the difference Li relevant to the plurality of parameters a to l of the function g.

At step ST17, the updater 14 (shown in FIG. 4) updates the plurality of parameters a to l of the function g according to the partial differential PDi.

As shown in FIG. 7, for example, when the integer i is 1, the plurality of parameters a to l of the function g are updated to a1 to l1, respectively. Similarly, as shown in FIG. 2, when the integer i is 2, the plurality of parameters a to l of the function g are updated to a2 to l2, respectively, and when the integer i is 3, the plurality of parameters a to l of the function g are updated to a3 to l3, respectively, and when the integer i is n, the plurality of parameters a to l of the function g are updated to an to In (not shown), respectively.

At step ST18, as a result of repeating step ST14 to step ST17, when the difference Li is recognized to have converged, for example, in comparison with a predetermined threshold value, the procedure proceeds to step ST19. On the other hand, when the difference Ll is recognized not to have converged, for example, in comparison with the predetermined value, the procedure proceeds to step ST13.

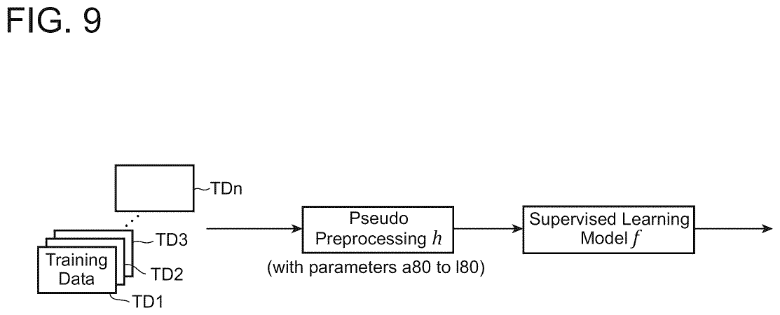

FIG. 9 shows a configuration of the controlling device CD according to the first embodiment when i reaches to 80.

At step ST19, the definer 11 defines pseudo preprocessing h by using the plurality of parameters a to l when i reaches to 80, that is, the plurality of parameters a80 to 180 as shown in FIG. 9. In addition thereto, the disposer 12 replaces the function g with the pseudo preprocessing h, and more specifically, removes the function g and disposes or place the pseudo preprocessing h previous to the supervised learning model f as shown in FIG. 9.

At step ST20, the trainer 15 (shown in FIG. 4) trains the supervised learning model f by using the pseudo preprocessing h, and more specifically, by providing the training data TD1 to TDn into the pseudo preprocessing h laid previous to the supervised learning model f as shown in FIG. 9.

At step 13, which follows the step ST18 that gives NO, the integer i is incremented by only one.

At step 2, the integer i is compared with 100 on the assumption above. If the integer i is smaller than 100, the procedure returns to step ST14; otherwise, the procedure ends.

### Effect of First Embodiment

As described above, the controlling device CD according to the first embodiment defines the pseudo preprocessing h by using the plurality of parameters a to l, and more definitely the plurality of parameters a80 to l80 that are given when the difference Li converges, that is, the integer i reaches to 80. Consequently, even though the plurality of parameters a to l of the function g are unknown or unreproducible, the supervised learning model f can be trained by using the pseudo preprocessing h in lieu of the function g.

### Second Embodiment

### Configuration of Second Embodiment

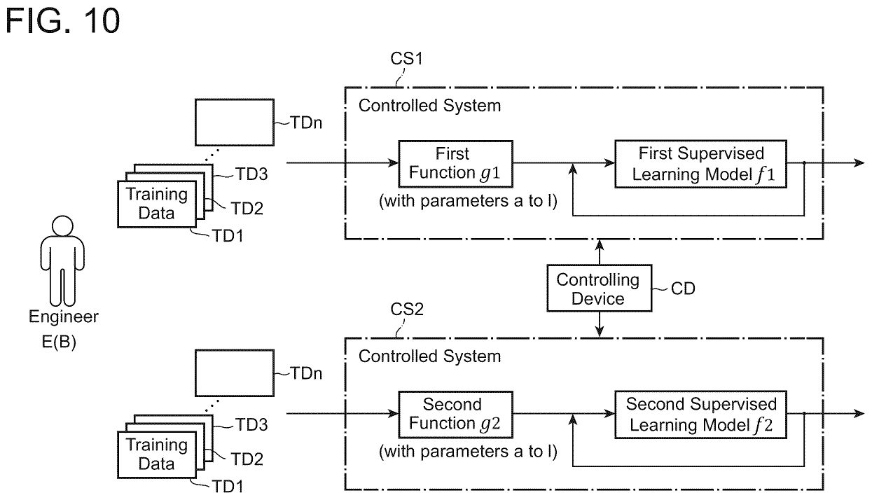

A controlling device according to a second embodiment of this disclosure will now be described with reference to FIGS. 10 to 15.

FIG. 10 is a block diagram showing configurations of a first controlled system CS1 and a second controlled system CS2 that are controlled by a controlling device CD according to the second embodiment. Similar to the controlling device CD of the first embodiment, the controlling device CD of the second embodiment controls, for example, both configurations and operations of the first controlled system CS1 and the second controlled system CS2.

As shown in FIG. 10, the first controlled system CS1 includes a first supervised learning model f1 and a first function g1, and the second controlled system CS2 includes a second supervised learning model f2 and a a second function g2. The operation of the first supervised learning model f1 and the operation of the second supervised learning model f2 are equivalent to each other. In the first controlled system CS1, the first function g1 is disposed or positioned previous to the first supervised learning model f1. Similarly, in the second controlled system CS2, the second function g2 is disposed or positioned previous to the second supervised learning model f2. In the second embodiment, an engineer E(B) desires to evaluate which of the first function g1 and the second function g2 is more robust by using training data TD1 to TDn. Evaluating the robustness of the first function g1 and the second function g2 will be described in detail later.

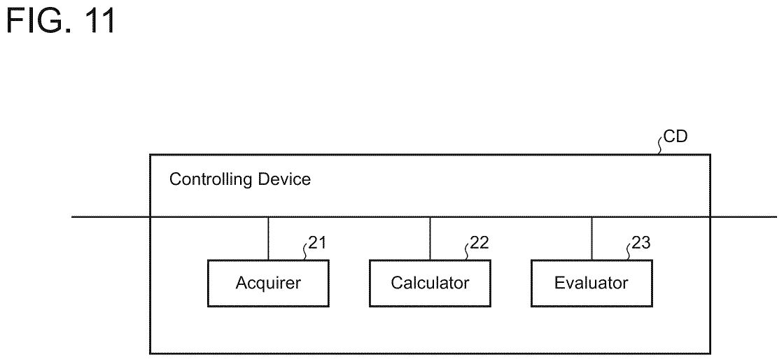

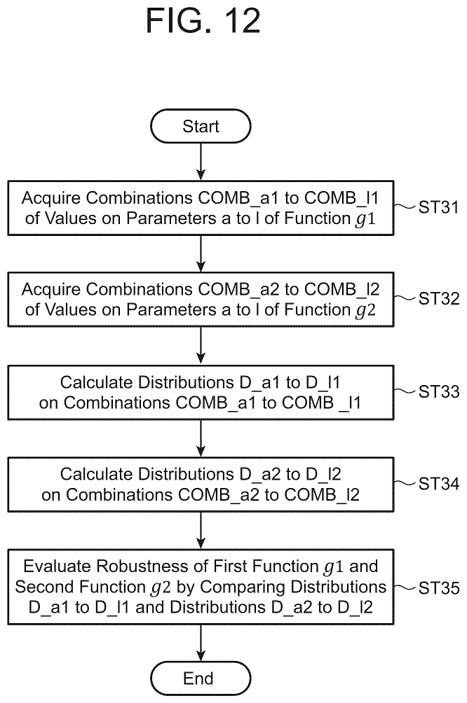

FIG. 11 is a block diagram showing a configuration of the controlling device CD according to the second embodiment from the functional viewpoint. As shown in FIG. 11, the controlling device CD according to the second embodiment includes an acquirer 21, a calculator 22, and an evaluator 23. The functions thereof will later be described with reference to the flowchart of FIG. 12.

Similar to the controlling device CD according to the first embodiment, the controlling device CD according to the second embodiment includes the input circuit IC, the processing circuit PC, and the output circuit OC (shown in FIG. 5). Alternatively, the controlling device CD according to the second embodiment may include the input circuit IC, the processor PR, the storage circuit SC, and the output circuit OC (shown in FIG. 6).

In lieu of the functions of the definer 11, the disposer 12, the calculator 13, the updater 14, and the trainer 15 in the first embodiment (shown in FIG. 4), the processing circuit PC (shown in FIG. 5) or the processor PR (shown in FIG. 6) implements the functions of the acquirer 21, the calculator 22, and the evaluator 23 (shown in FIG. 11).

### Operation of Second Embodiment

FIG. 12 is a flowchart showing an operation of the controlling device CD according to the second embodiment.

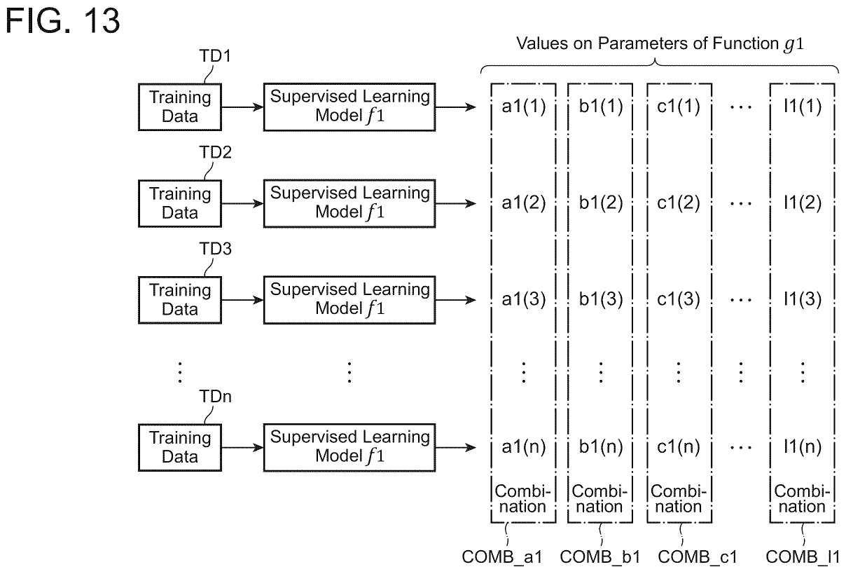

FIG. 13 shows a plurality of combinations COMB_a1 to COMB_l1 including a variety of values related to a plurality of parameters a to l of the first function g1.

At step ST31, the acquirer 21 (shown in FIG. 11) acquires a plurality of combinations COMB_a1 to COMB_l1 shown in FIG. 13. Each of the plurality of combinations COMB_a1 to COMB_l1 includes a variety of values relevant to one of the plurality of parameters a to l of the first function g1 (shown in FIG. 10).

For example, as shown in FIG. 13, the combination COMB_a1 includes a variety of values a1(1), a1(2), a1(3), , , and a1(n) on the parameter a of the first function g1. Herein, the variety of values a1(1), a1(2), a1(3), , , , and a1(n) are outputs returned or feedbacked by the first supervised learning model f1 depending on the training data TD1, TD2, TD3, , , , and TD(n).

For example, the value a1(1) is an output returned by the first supervised learning model f1 depending on the training data TD1, the value a1(2) is an output returned by the first supervised learning model f1 depending on the training data TD2, , , , and the value a1(n) is an output returned by the first supervised learning model f1 depending on the training data TDn.

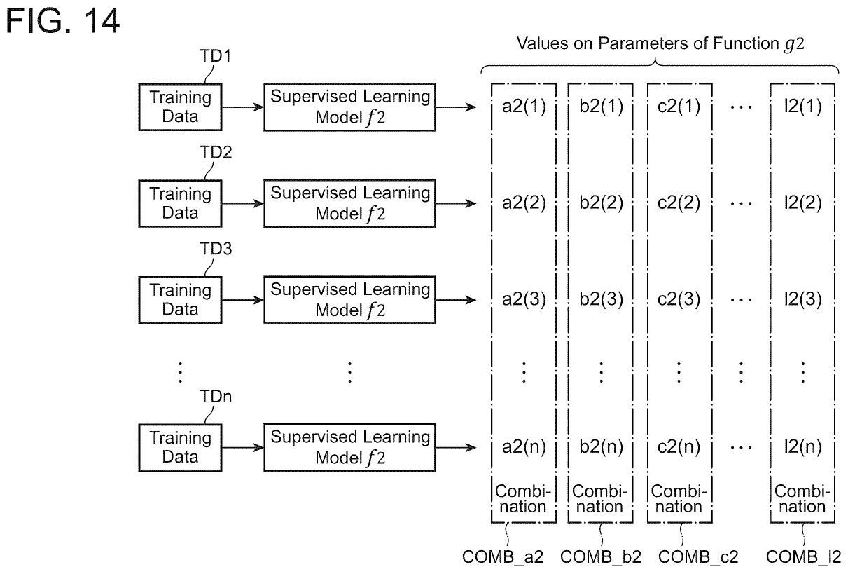

FIG. 14 shows a plurality of combinations COMB_a2 to COMB_l2 including a variety of values on a plurality of parameters a to l of the second function g2.

At step ST32, the acquirer 21 acquires a plurality of combinations COMB_a2 to COMB_l2. Each of the plurality of combinations COMB_a2 to COMB_l2 includes a variety of values on one of the plurality of parameters a to l of the second function g2.

For example, as shown in FIG. 14, the combination COMB_a2 includes a variety of values a2(1), a2(2), a2(3), , , , and a2(n) on the parameter a of the second function g2. Herein, the variety of values a2(1), a2(2), a2(3), , , , and a2(n) are outputs returned or feedbacked by the second supervised learning model f2 depending on the training data TD1, TD2, TD3, , , , and TD(n).

For example, the value a2(1) is an output returned by the second supervised learning model f2 depending on the training data TD1, the value a2(2) is an output returned by the second supervised learning model f2 depending on the training data TD2, , , , and the value a2(n) is an output returned by the second supervised learning model f2 depending on the training data TDn.

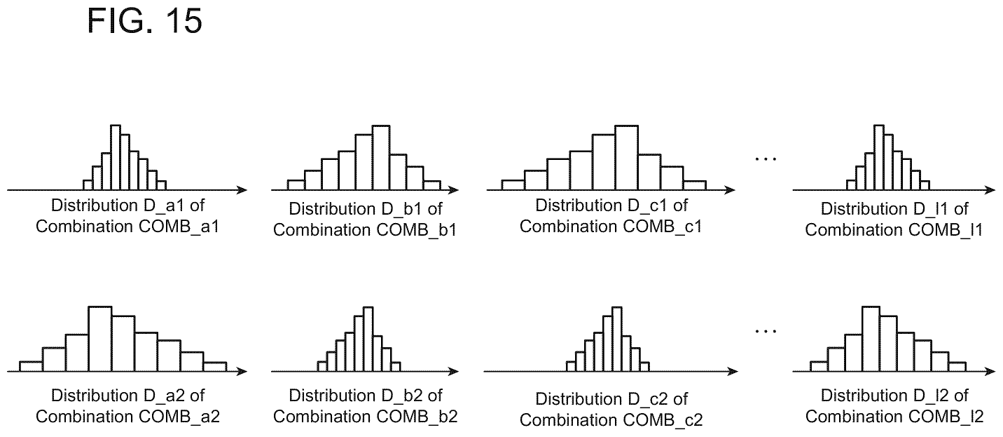

FIG. 15 shows a plurality of distributions D_a1 of the combination COMB_a1 to D_l1 of the combination COMB_l1, and a plurality of distributions D_a2 of the combination COMB_a2 to D_l2 of the combination COMB_l2.

At step ST33, the calculator 22 (shown in FIG. 11) calculates a plurality of distributions D_a1 (shown in FIG. 15) of the combination COMB_a1 (shown in FIG. 13) to D_l1 (shown in FIG. 15) of the combination COMB_l1 (shown in FIG. 13). More definitely, the calculator 22 calculates, for example, the distribution D_a1 of the combination COMB_a1 that includes the variety of values a1(1), a1(2), a1(3), , , , and a1(n) (shown in FIG. 13) related to the parameter a of the first function g1 (shown in FIG. 10). As shown in FIG. 15, the distribution D_a1 of the combination COMB_a1 has an expanse or a spread peculiar to the distribution D_a1.

Similar to calculating the distribution D_a1, the calculator 22 calculates the other distributions D_b1 to D_l1, wherein each of the distributions D_b1 to D_l1 has an expanse or a spread peculiar thereto.

At step ST34, the calculator 22 calculates a plurality of distributions D_a2 (shown in FIG. 15) of the combination COMB_a2 (shown in FIG. 14) to D_l2 (shown in FIG. 15) of the combination COMB_l2 (shown in FIG. 14). More definitely, the calculator 22 calculates, for example, the distribution D_a2 of the combination COMB_a2 that includes the variety of values a2(1), a2(2), a2(3), , , , and a2(n) (shown in FIG. 14) related to the parameter a of the second function g2 (shown in FIG. 10). As shown in FIG. 15, the distribution D_a2 of the combination COMB_a2 has an expanse or a spread peculiar to the distribution D_a2.

Similar to the calculation of the distribution D_a2, the calculator 22 calculates the other distributions D_b2 to D_l2, wherein each of the distributions D_b2 to D_l2 has an expanse or a spread peculiar thereto.

At step ST35, the evaluator 23 (shown in FIG. 11) evaluates which of the first function g1 (shown in FIG. 10) and the second function g2 (shown in FIG. 10) is more robust, by comparing the expanses or spreads of the plurality of distributions D_a1 to D_l1 (shown in FIG. 15) and the expanses or the spreads of the plurality of distributions D_a2 to D_l2 (shown in FIG. 15), respectively.

For example, the evaluator 23 compares the expanse or the spreads of the distribution D_a1 and the expanse or the spread of the distribution D_a2. Since the distribution D_a2 expands or spreads more widely in comparison with the distribution D_a1 as shown in FIG. 15, the evaluator 23 evaluates the second function g2 is more robust than the first function g1 from the viewpoint of the distributions D_a1 and D_a2.

Similar to the expanses or the spreads of the distributions D_a1 and D_a2, the evaluator 23 compares the expanses or the spreads of the distributions D_b1 and D_b2, D_c1 and D_c2, , , , and D_l1 and D_l2.

The evaluator 23 evaluates which of the first function g1 and the second function g2 is more robust in consideration of all the results of comparing the distributions D_a1 and D_a2, the distributions D_b1 and D_b2, the distributions D_c1 and D_c3, , , , and the distributions D_l1 and D_l2.

### Effect of Second Embodiment

As described above, the controlling device CD according to the second embodiment respectively compares the expanses or the spreads of the distributions D_a1 to D_l1 with the expanses or the spreads of the distributions D_a2 to D_l2, which enables evaluating which of the first function g1 and the second function g2 is more robust.

### Third Embodiment

### Configuration of Third Embodiment

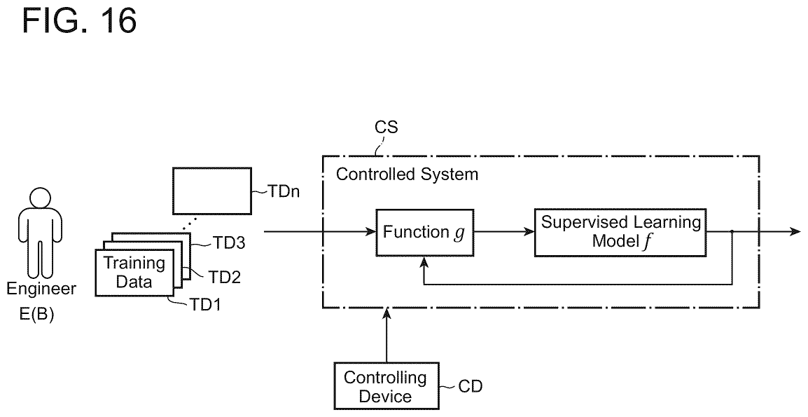

A controlling device according to a third embodiment of this disclosure will now be described with reference to FIGS. 16 to 22.

FIG. 16 is a block diagram showing a configuration of a controlled system CS that is controlled by a controlling device CD according to the third embodiment. Similar to the controlling device CD of the first embodiment, the controlling device CD of the third embodiment controls, for example, both a configuration and an operation of the controlled system CS.

As shown in FIG. 16, the controlled system CS includes a supervised learning model f and a function g, where the function g is disposed or laid previous to the supervised learning model f. In the third embodiment, an engineer E(B) desires to assign a variety of values to a plurality of parameters a to l of the function g by using training data TD1 to TDn. The assigning above will be described in detail later.

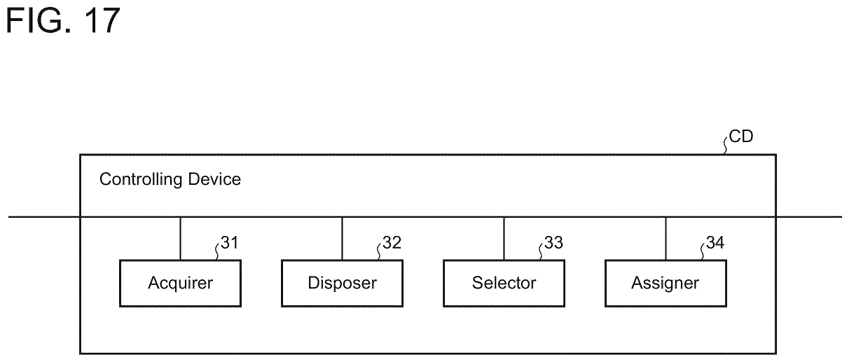

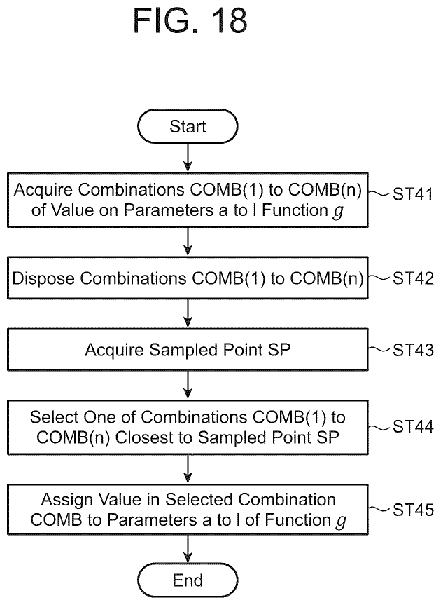

FIG. 17 is a block diagram showing a configuration of the controlling device CD according to the third embodiment from the functional viewpoint. As shown in FIG. 17, the controlling device CD according to the third embodiment includes an acquirer 31, a disposer 32, a selector 33, and an assigner 34. The functions thereof will later be described with reference to the flowchart of FIG. 18.

Similar to the controlling device CD according to the first embodiment, the controlling device CD includes the input circuit IC, the processing circuit PC, and the output circuit OC (shown in FIG. 5). Alternatively, the controlling device CD according to the third embodiment may include the input circuit IC, the processor PR, the storage circuit SC, and the output circuit OC (shown in FIG. 6).

In lieu of the functions of of the definer 11, the disposer 12, the calculator 13, the updater 14, and the trainer 15 in the first embodiment (shown in FIG. 4), the processing circuit PC (shown in FIG. 5) or the processor PR (shown in FIG. 6) implements the functions of the acquirer 31, the disposer 32, the selector 33, and the assigner 34 (shown in FIG. 17).

### Operation of Third Embodiment

FIG. 18 is a flowchart showing an operation of the controlling device CD according to the third embodiment.

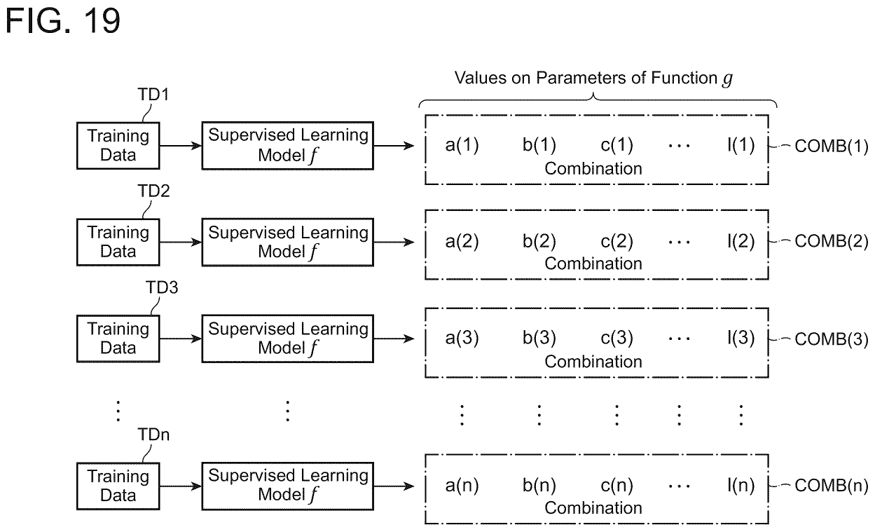

FIG. 19 shows a plurality of combinations COMB(1) to COMB(n) including a variety of values related to a plurality of parameters a to l of the function g.

At step ST41, the acquirer 31 (shown in FIG. 17) acquires a plurality of combinations COMB(1) to COMB(n) (shown in FIG. 19). Each of the plurality of combinations COMB(1) to COMB(n) includes a variety of values relevant to the plurality of parameters a to l of the function g.

For example, as shown in FIG. 19, the combination COMB(1) includes a variety of values a(1), b(1), c(1), , , , and l(1) relevant to the plurality of parameters a to l of the function g. Herein, the variety of values a(1), b(1), c(1), , , , and l(1) are outputs returned or feedbacked by the supervised learning model f depending on the training data TD1, the variety of values a(2), b(2), c(2), , , , and l(2) are outputs returned by the supervised learning model f depending on the training data TD2, , , , ; and the variety of values a(n), b(n), c(n), , , , and l(n) are outputs returned by the supervised learning model f depending on the training data TDn.

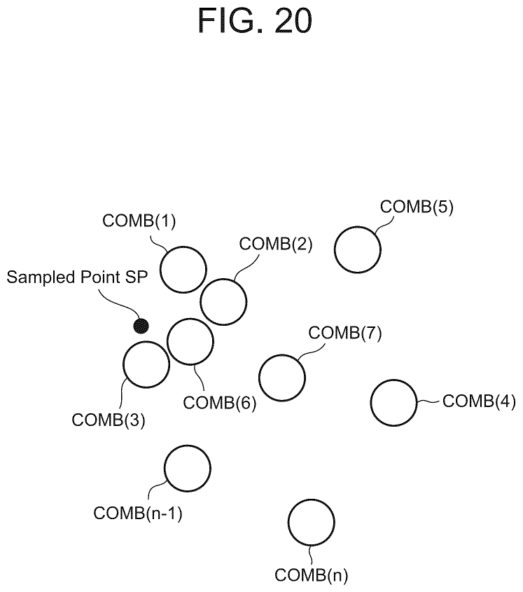

FIG. 20 shows the plurality of combinations COMB(1) to COMB(n) and a sampled point SP that are disposed in space.

At step ST42, the disposer 32 (shown in FIG. 17) disposes or positions the plurality of combination COMB(1) to COMB(n) in 12-dimension space, number of which is equivalent to the number of the plurality of parameters a to l of the function g, as shown in FIG. 20.

At step ST43, the acquirer 31 acquires a sampled point SP, for example, by using a well-known scheme or method, as shown in FIG. 20.

At step 44, among the plurality of combinations COMB(1) to COMB(n) shown in FIG. 20, the selector 33 (shown in FIG. 17) selects one that is positioned or laid closest to the sampled point SP, that is, the combination COMB(3).

At step 45, the assigner 34 (shown in FIG. 17) assigns the selected combination COMB(3), more specifically, the variety of values a(3), b(3), c(3), , , , and l(3) (shown in FIG. 19) included in the selected combination COMB(3), to the plurality of parameters a to l of the function g.

### Effect of Third Embodiment

As described above, the controlling device CD according to the third embodiment selects among the plurality of combinations COMB(1) to COMB(n), one that is placed or laid closest to the sampled point SP, and more concretely selects the combination COMB(3), which enables assigning the variety of values a(3), b(3), c(3), , , , and l(3) that are possibly suitable to the plurality of parameters a to I of the function g.

### Modification of Third Embodiment

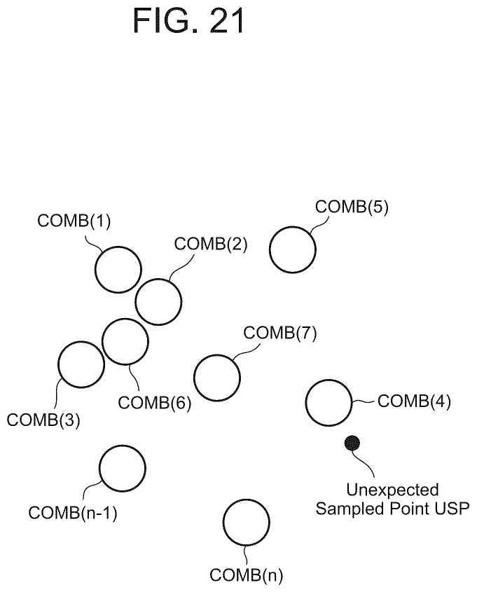

FIG. 21 shows the plurality of combinations COMB(1) to COMB(n) and an unexpected sampled point SP.

The above well-know scheme or method used on the sampled point SP may give an unexpected sampled point USP (shown in FIG. 21), which is positioned or laid farther or the farthest from a group of several combinations, for example, COMB(3), COM(6), COMB(2), and COMB(1), in lieu of the sampled point SP (shown in FIG. 20), which is rather expected to the above group. If only the unexpected sampled point USP is available for the selecting at step ST44 above, the assigning at step ST45 cannot give any values suitable for the plurality of parameters a to l of the function g.

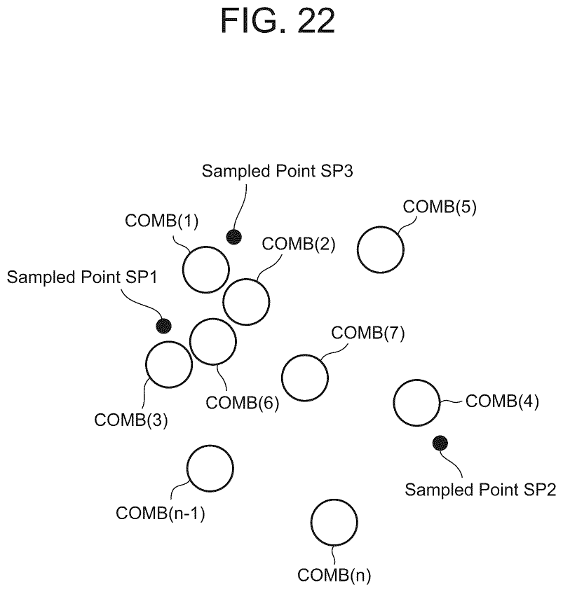

FIG. 22 shows the plurality of combinations COMB(1) to COMB(n) and the sampled points SP1, SP2, and SP3.

To enhance the accuracies of both the selecting and the assigning above, in the modification of the third embodiment, as shown in FIG. 22, the acquirer 31 (shown in FIG. 17) acquires several sampled points, for example, three sampled points SP1, SP2, and SP3 in lieu of the one sampled point SP in the third embodiment (shown in FIG. 20). Even if the sampled point SP2 is unexpected, at least one of the other sampled points SP1 and SP3 may be possibly expected, which enables the selector 33 to select the combination COMB(3) placed or laid closest to the sampled point SP1, or the combination COMB(1) placed or laid closest to the sampled point SP3. This allows assigning the variety of values included in the combination COMB(3) or COMB(1) that are possibly suitable to the plurality of parameters a to l of the function g, similar to the third embodiment.

1. A method comprising:
defining a function g with a plurality of parameters a to l;
disposing the function g previous to a supervised learning model f; the supervised learning model f being trained with training data TDi including an example xi and a label yi, and i being an integer;
defining a function f(g(xi)) by using the supervised learning model f and the function g;
calculating a result Zi by calculating the function f(g(xi));
calculating a difference Li between the result Zi and the label yi;
calculating a partial differential PDi of the difference Li on the plurality of parameters a to l of the function g;
updating the plurality of parameters a to l of the function g according to the partial differential PDi;
defining a pseudo preprocessing h by using the plurality of parameters a to l of the function g when the difference Li converges during repetition between the calculating of the result Zi and the updating of the plurality of parameters a to l of the function g;
disposing the pseudo preprocessing h previous to the supervised learning model f; and
training the supervised learning model f by providing the training data TDi to the pseudo preprocessing h.

2. A method comprising:
acquiring a first plurality of combinations COMB_a1 to COMB_l1 that each include a variety of values on one of a plurality of parameters a to l of a first function g1 that is disposed previous to a first supervised learning model f1 that implements feedback to the first function g1, by providing training data TDi to the first supervised learning model f1, i being an integer;
acquiring a second plurality of combinations COMB_a2 to COMB_l2 that each include a variety of values on one of a plurality of parameters a to l of a second function g2 that is disposed previous to a second supervised learning model f2 that is implements feedback to the second function g2, by providing training data TDi to the second supervised learning model f2, operation of the first supervised learning model f1 and operation of the second supervised learning model f2 being equivalent to each other;
calculating a first plurality of distributions D_a1 to D_l1 on the first plurality of combinations COMB_a1 to COMB_l1 respectively;
calculating a second plurality of distributions D_a2 to D_l2 on the second plurality of combinations COMB_a2 to COMB_l2 respectively; and
evaluating which of the first function g1 and the second function g2 is more robust by comparing the first plurality of distributions D_a1 to D_l1 and the second plurality of distributions D_a2 to D_l2 respectively.

3. A method comprising:
acquiring a plurality of combinations COMB(1) to COMB(n) that each include a plurality of values on a plurality of parameters a to l of a function g that is disposed previous to a supervised learning model f that implements feedback to the function g, by providing training data TDi to the supervised learning model f, n being an integer equal to or more than two;
disposing the plurality of combinations COMB(1) to COMB(n) in space that has a plurality of dimensions of which number is equivalent to a number of the plurality of parameters a to l of the function g;
acquiring at least one sampled point SP in the space;
selecting at least one among the plurality of combinations COMB(1) to COMB(n) that is closest to the at least one sampled point SP; and
assigning the plurality of values included in the selected one of the plurality of combinations COMB(1) to COMB(n) to the plurality of parameters a to l of the function g.

4. A device comprising:
a first definer that defines a function g with a plurality of parameters a to l;
a first disposer that disposes the function g previous to a supervised learning model f; the supervised learning model f being trained with training data TDi including an example xi and a label yi, and i being an integer;
a second definer that defines a function f(g(xi)) by using the supervised learning model f and the function g;
a first calculator that calculates a result Zi by calculating the function f(g(xi));
a second calculator that calculates a difference Li between the result Zi and the label yi;
a third calculator that calculates a partial differential PDi of the difference Li on the plurality of parameters a to l of the function g;
an updater that updates the plurality of parameters a to l of the function g according to the partial differential PDi;
a third definer that defines a pseudo preprocessing h by using the plurality of parameters a to l of the function g when the difference Li converges during repetition between the calculating of the result Zi and the updating of the plurality of parameters a to l of the function g;
a second disposer that disposes the pseudo preprocessing h previous to the supervised learning model f; and
a trainer that trains the supervised learning model f by providing the training data TDi to the pseudo preprocessing h.

5. A device comprising:
a first acquirer that acquires a first plurality of combinations COMB_a1 to COMB_l1, each of which includes a variety of values on one of a plurality of parameters a to l of a first function g1 that is disposed previous to a first supervised learning model f1 that implements feedback to the first function g1, by providing training data TDi to the first supervised learning model f1, i being an integer;
a second acquirer that acquires a second plurality of combinations COMB_a2 to COMB_l2, each of which includes a variety of values on one of a plurality of parameters a to l of a second function g2 that is disposed previous to a second supervised learning model f2 that is implements feedback to the second function g2, by providing training data TDi to the second supervised learning model f2, operation of the first supervised learning model f1 and operation of the second supervised learning model f2 being equivalent to each other;
a first calculator that calculates a first plurality of distributions D_a1 to D_l1 on the first plurality of combinations COMB_a1 to COMB_l1 respectively;
a second calculator that calculates a second plurality of distributions D_a2 to D_l2 on the second plurality of combinations COMB_a2 to COMB_l2 respectively; and
an evaluator that evaluates which of the first function g1 and the second function g2 is more robust by comparing the first plurality of distributions D_a1 to D_l1 and the second plurality of distributions D_a2 to D_l2 respectively.

6. A device comprising:
a first acquirer that acquires a plurality of combinations COMB(1) to COMB(n) that each include a plurality of values on a plurality of parameters a to l of a function g that is disposed previous to a supervised learning model f that implements feedback to the function g, by providing training data TDi to the supervised learning model f, n being an integer equal to or more than two;
a disposer that disposes the plurality of combinations COMB(1) to COMB(n) in space that has a plurality of dimensions of which number is equivalent to a number of the plurality of parameters a to l of the function g;
a second acquirer that acquires at least one sampled point SP in the space;
a selector that selects at least one among the plurality of combinations COMB(1) to COMB(n) that is closest to the at least one sampled point SP; and
an assigner that assigns the plurality of values included in the selected one of the plurality of combinations COMB(1) to COMB(n) to the plurality of parameters a to l of the function g.
